(19) United States
(12) Patent Application Publication
(10) Pub. No.: US 2012/0218343 A1
(43) Pub. Date: Aug. 30, 2012

(54) MIXTURES OF CYAN DYES AND INKS THEREOF FOR USE IN INK-JET PRINTING

(76) Inventor: Prakash Patel, Manchester (GB)

(21) Appl. No.: 13/503,143

(22) PCT Filed: Oct. 8, 2010
(86) PCT No.: PCT/GB10/51693

§ 371 Date: Apr. 20, 2012

(30) Foreign Application Priority Data
Oct. 23, 2009 (GB) 0918608.1

(51) Int. Cl. B41J 2/175; C09D 11/02; C09B 47/04

(52) U.S. Cl. 347/20; 106/413; 106/31.49; 347/86; 347/105

(57) ABSTRACT

A mixture of dyes and salts thereof comprising:
(a) dyes of Formula (1) and salts thereof:

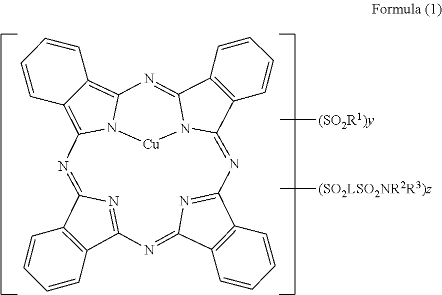

wherein:
   R¹ is optionally substituted C₁₋₈alkyl;
   R² is H or methyl;
   R³ is H or optionally substituted C₁₋₄alkyl;
   L is optionally substituted C₁₋₄alkyl;
   y is 1 to 3;
   z is 1 to 3; and
   y+z is 2 to 4: and
(b) an acid triphenylmethane dye and salts thereof:
wherein the ratio of the components (a) and (b) is in the range of from 95:5 to 5:95 parts by weight. Also compositions, inks, printing processes, printed materials and ink-jet cartridges

This invention relates to dyes mixtures, to compositions and inks for ink-jet printers, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras it is becoming increasingly common for consumers to print off photographs using an ink-jet printer.

While ink-jet printers have many advantages over other forms of printing and image development there are many technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed, but they should not form a crust over the tiny nozzles in the printer head. Storage stability is also important to avoid particle formation that could block the tiny nozzles used in the printer especially since consumers can keep an ink-jet ink cartridge for several months. Furthermore, and especially important with photographic quality reproductions, the resultant images should not bronze or fade rapidly on exposure to light or common oxidising gases such as ozone.

For high quality photorealistic ink-jet printing it is especially important that the shade and chroma of each colorant is exactly right so that any image may be optimally reproduced. To achieve this more than one colorant may be used in the ink.

Selecting which colorants to use in an ink is an art in itself since the chemist has to identify which mixture of colorants will yield a print with the required optical properties on a variety of diverse substrates. The chemist must also ensure that the selected mixture of colorants yield an ink which meets the demanding performance criteria as set out above. They also have to minimise the cost of the colorant(s), the most expensive component of the ink, without adversely effecting the inks performance.

The present invention provides a mixture of dyes comprising:

(a) dyes of Formula (1) and salts thereof:

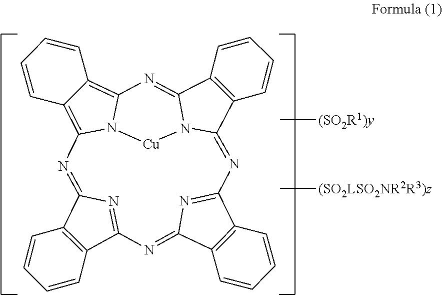

wherein:

R¹ is optionally substituted C₁₋₈alkyl;

R² is H or methyl;

R³ is H or optionally substituted C₁₋₄alkyl;

L is optionally substituted C₁₋₄alkylene;

y is 1 to 3;

z is 1 to 3; and

y+z is 2 to 4: and

(b) an acid triphenylmethane dye and salts thereof:
wherein the ratio of the components (a) and (b) is in the range of from 95:5 to 5:95 parts by weight.

Preferably R¹ is C₁₋₄ alkyl carrying one or more substituents selected from the group consisting of —OH, —SO₃H, —CO₂H and —PO₃H₂. More preferably R¹ is C₁₋₄ alkyl carrying one or more —SO₃H groups. It is particularly preferred that R¹ is a group of formula —CH₂CH₂CH₂—SO₃H.

Preferably R² is H.

Preferably R³ is C₁₋₄alkyl carrying at least one substituent selected from the group consisting of —OH, —SO₃H, —CO₂H and —PO₃H₂. It is particularly preferred that R³ is a group of formula —CH₂CHOHCH₃.

Preferably L is unsubstituted C₁₋₄alkylene. More preferably L is a group of formula —CH₂CH₂—.

Preferably y+z is 3 to 4 and more preferably 4.

Preferably there is no more than one substituent represented by y and z bound to each component ring of the phthalocyanine nucleus.

Preferably the groups represented by y and z are bound to the phthalocyanine only through the β-position.

Preferably the dye of Formula (1) and salts thereof is of Formula (2) and salts thereof:

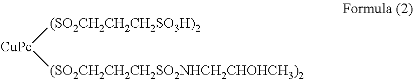

wherein:

Pc represents a phthalocyanine nucleus of formula

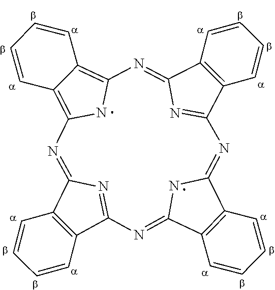

and the pendant groups are bound to the phthalocyanine nucleus only through the β-position.

Preferably the acid triphenylmethane dye is one listed in the Color Index more preferably the acid triphenylmethane dye is C.I. Acid Blue 9 or a salt thereof.

C.I. Acid Blue 9 is commercially available from a number of suppliers. Preferably prior to use C.I. Acid Blue 9 is purified so as to convert it to a form suitable for ink jet printing. Preferred purification steps include reverse osmosis to remove inorganic impurities and screening to remove particulate matter.

Preferably the ratio of the components (a) and (b) is in the range of from 95:5 to 25:75 parts by weight, more preferably in the range of from 75:25 to 25:75 and especially in the range of from 85:15 to 65:35 parts by weight.

In a second embodiment the ratio of the components (a) and (b) is in the range of from 55:45 to 45:55 parts by weight.

The mixture of dyes according to the present invention may be used in the preparation of cyan inks for use in ink-jet printing. They may also be used to shade other coloured inks.

The dyes of Formula (1) are among the most effective of all cyan ink-jet dyes. However, they are extremely expensive to make. The applicants have found that by mixing the dyes of Formula (1) with the generally much cheaper acid triphenylmethane dyes it is possible to obtain a dye mixture which surprisingly shows a technical performance close to that seen with the dyes of Formula (1) alone but which has a much lower unit cost. The applicants have also found that mixtures of dyes according to the present invention have a higher optical density when printed than would be predicted from the optical densities of the component dyes.

Acid and basic groups on the dyes shown herein, particularly acid groups, are preferably in the form of a salt. Thus, the Formulae shown herein include the compounds in free acid and in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially lithium and sodium salts.

The dyes disclosed herein may be converted into a salt using known techniques.

The dyes disclosed herein may exist in tautomeric forms other than those shown in this specification. These tautomers are included within the scope of the present invention.

The dyes of Formula (1) may be prepared using those processes described in U.S. Pat. No. 7,211,134 which is incorporated herein by reference.

According to a second aspect of the present invention there is provided a composition comprising a mixture of dyes and/or salts thereof, as described in the first aspect of the invention, and a liquid medium.

Preferred compositions according to the second aspect of the invention comprise:
(a) from 0.01 to 30 parts of a mixture of dyes and salts thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration cyan ink, a low concentration cyan ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties.

It is preferred that the composition according to the invention is ink suitable for use in an ink-jet printer. Ink suitable for use in an ink-jet printer is ink which is able to repeatedly fire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying a composition, preferably ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred. Photographic quality paper give a similar finish to that typically seen with silver halide photo printing.

A fourth aspect of the present invention provides a material preferably paper, plastic, a textile, metal or glass, more preferably paper, an overhead projector slide or a textile material, especially paper more especially plain, coated or treated papers printed with a mixture of dyes and/or salts thereof as described in the first aspect of the invention, a composition according to the second aspect of the invention or by means of a process according to the third aspect of the invention.

It is especially preferred that the printed material of the fourth aspect of the invention is a print on a photographic quality paper printed using a process according to the third aspect of the invention.

A fifth aspect of the present invention provides an ink-jet printer cartridge comprising a chamber and a composition, preferably ink suitable for use in an ink-jet printer, wherein the composition is in the chamber and the composition is as defined and preferred in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated.

### EXAMPLE 1

### Preparation of the Lithium Salt of

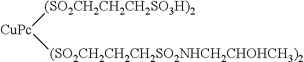

Prepared as described in Example 105, U.S. Pat. No. 7,211,134.

### EXAMPLE 2

A mixture of dyes was prepared by mixing 83 parts of the Dye of Example 1 with 17 parts of C.I. Acid Blue 9.

### EXAMPLE 3

### Preparation of Inks

An Example Ink and two Control Inks, one containing the Dye of Example 1 and the other C.I. Acid Blue 9, were prepared by dissolving 3.2 g dye mixture of in a liquid medium comprising (% by weight):

| | |
|---|---|
| Diethyleneglycol | 7% |
| 2-Pyrollidone | 7% |
| Ethyleneglycol | 7% |
| Surfynol^{RTM} 465 | 1% |
| Tris buffer | 0.2% |
| Water | 77.8% |

Surfynol® 465 is a surfactant from Air Products.

### EXAMPLE 4

### Ink-Jet Printing

Ink prepared as described above was filtered through a 0.45 micron nylon filter and then incorporated into empty print cartridges using a syringe.

These inks were then ink-jet printed on to the following ink-jet media:

Epson® Ultra Premium Glossy Photo Paper (SEC PM);

Canon® Photo Paper Pro Platinum PT101 Photo Paper (PT101); and

HP Advanced Photo Paper (HPP).

Canon GF500 paper (GF500)

Xerox Acid® 4200 Copy Paper (XA4200)

### Print Measurement

The reflectance spectra of the prints were obtained using a Gretag Spectrolino® spectrophotometer set to the following parameters:

Measuring Geometry: 0°/45°

Spectral Range: 380-730 nm

Spectral Interval: 10 nm

Illuminant: D50

Observer: 2° (CIE 1931)

Density: Ansi A

External: Filler None

### Calculation of the Predicted ROD

The one constant Kubelka-Munk model was used to convert the reflectance spectrum (R) into the ratio of the absorption coefficient (K) to scattering coefficient (S) (Kang, H. R. J. Imag. Tech., 17, 2, 1991, 76-83). This ratio is then treated as a single entity.

$$\frac{K}{S} = \frac{{( 1 - R )}^{2}}{2 R}$$

This model assumes that there are no boundaries in the system (i.e. no correction is used for the refractive index change between air and print) and the scattering is assumed to be constant. Also the K/S ratios for individual components are assumed to be additive at each wavelength: Thus

$$\frac{K}{S} = {( \frac{K}{S} )}_{1} + {( \frac{K}{S} )}_{2}$$

The K/S values for the wavelength range of 380 to 730 nm for the inks were calculated from the reflectance spectra measured at 100% print depth as described above.

The K/S values for the Dye of Example 1 and Acid Blue 9 were scaled to the following levels to give the appropriate dye concentration in the blend.
C037: 0.83
Acid Blue 9: 0.17

The scaled K/S spectra for each dye on each paper were then summed at each wavelength to give the K/S values for the blend spectrum on each paper.

Blend spectra were calculated on different papers using the reflectance spectra of both dyes that were measured on the same paper.

The blend K/S spectrum was then converted into the corresponding reflectance spectrum using the following equation, where R=reflectance. The K/S ratio is again treated as a single entity.

$$R = 1 + \frac{K}{S} - {[ {( 1 + \frac{K}{S} )}^{2} - 1 ]}^{\frac{1}{2}}$$

### Results

| Substrate | Predicted ROD | Actual ROD |
|---|---|---|
| PT101 | 1.92 | 2.09 |
| HPP | 1.81 | 2.07 |
| SEC PM | 1.88 | 1.95 |
| GF 500 | 1.01 | 1.15 |
| XA4200 | 1.01 | 1.12 |

Clearly a mixture of a dye of Formula (1) and an acid triphenylmethane dye, when printed, has an enhanced ROD over that predicted from the calculated spectra.

### Further Inks

The inks described in Tables A and B may be prepared using the mixture of dyes as described in Example 2. The mixture of dyes indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | Water | PG | DEG | NMP | TBT | BDL | PI2 |
|---|---|---|---|---|---|---|---|
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A mixture of dyes and salts thereof comprising:
(a) dyes of Formula (1) and salts thereof: 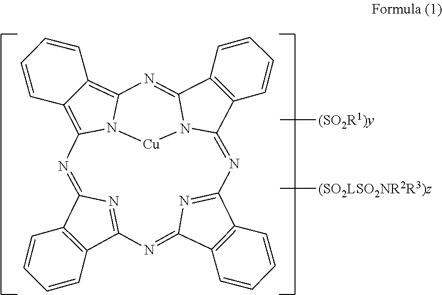
wherein:
R¹ is optionally substituted C₁₋₈alkyl;
R² is H or methyl;
R³ is H or optionally substituted C₁₋₄alkyl;
L is optionally substituted C₁₋₄alkyl;
y is 1 to 3;
z is 1 to 3; and
y+z is 2 to 4: and
(b) an acid triphenylmethane dye and salts thereof:
wherein the ratio of the components (a) and (b) is in the range of from 95:5 to 5:95 parts by weight.

2. A mixture of dyes and salts thereof as claimed in claim 1 wherein R¹ is C₁₋₄ alkyl carrying one or more substituents selected from the group consisting of —OH, —SO₃H, —CO₂H and —PO₃H₂

3. A mixture of dyes and salts thereof as claimed in claim 1 wherein R¹ is a group of formula —CH₂CH₂CH₂—SO₃H.

4. A mixture of dyes and salts thereof as claimed in claim 1 wherein R² is H.

5. A mixture of dyes and salts thereof as claimed in claim 1 wherein R³ is C₁₋₄alkyl carrying at least one substituent selected from the group consisting of —OH, —SO₃H, —CO₂H and —PO₃H₂.

6. A mixture of dyes and salts thereof as claimed in claim 1 wherein R³ is a group of formula —CH₂CHOHCH₃.

7. A mixture of dyes and salts thereof as claimed in claim 1 wherein L is a group of formula —CH₂CH₂—.

8. A mixture of dyes and salts thereof as claimed in claim 1 wherein y+z is 4.

9. A mixture of dyes and salts thereof as claimed in claim 1 wherein the groups represented by y and z are bound to the phthalocyanine only through the β-position.

10. A mixture of dyes and salts thereof as claimed in claim 1 wherein the dye of Formula (1) and salts thereof is of Formula (2) and salts thereof: 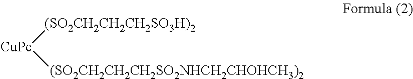
wherein:
Pc represents a phthalocyanine nucleus of formula 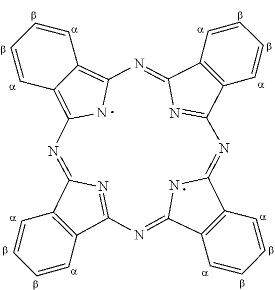
and the pendant groups are bound to the phthalocyanine nucleus only through the β-position.

11. A mixture of dyes and salts thereof as claimed in claim 1 wherein the acid triphenylmethane dye is C.I. Acid Blue 9 or a salt thereof.

12. A mixture of dyes and salts thereof as claimed in claim 1 wherein the ratio of the components (a) and (b) is in the range of from 85:15 to 65:35 parts by weight.

13. A composition comprising a mixture of dyes and salts thereof, as described in claim 1, and a liquid medium.

14. A composition as claimed in claim 13 which is ink suitable for use in an ink-jet printer.

15. A process for forming an image on a substrate comprising applying ink suitable for use in an ink-jet printer, according to claim 14, thereto by means of an ink-jet printer.

16. A material printed with a mixture of dyes and salts thereof as described in claim 1.

17. An ink-jet printer cartridge comprising a chamber and ink suitable for use in an ink-jet printer, according to claim 14, wherein the ink is in the chamber.
